(19) United States
(12) Patent Application Publication
(10) Pub. No.: US 2004/0137410 A1
(43) Pub. Date: Jul. 15, 2004

(54) Assembly to connect prosthetic teeth to dental models

(76) Inventor: Anopet Phimmasone, Springfield, VA (US)

Correspondence Address: W. Robinson H. Clark Esq., DORSEY & WHITNEY LLP, Suite 400 South, 1001 Pennsylvania Avenue NW, Washington, DC, 20004, US

(21) Appl. No.: 10/750,888

(22) Filed: Jan. 5, 2004

Related U.S. Application Data
(60) Provisional application No. 60/438,304, filed on Jan. 7, 2003.

(51) Int. Cl. A61C 11/00; A61C 8/00

(52) U.S. Cl. 433/213; 433/173

(57) ABSTRACT

The invention is an assembly that connects prosthetic teeth to dental models. The assembly forms a two part analog pin that snaps into a sleeve. Also disclosed are kits for installing the assembly, dental models that contain the assembly, and methods for making dental models that contain the assembly. The assembly expedites the connection and separation of prosthetic teeth to and from dental modes and can be employed with dry set dowel pins.

### RELATED APPLICATIONS

This application claims priority to Provisional Patent Application No. 60/438,304, of the same title, filed Jan. 7, 2003, and designated Attorney Docket No. 12648P.

### FIELD OF THE INVENTION

The invention is an assembly that connects prosthetic teeth to dental models. The assembly forms a two part analog pin that snaps into a sleeve. Also disclosed are kits for installing the assembly, dental models that contain the assembly, and methods for making dental models that contain the assembly. The assembly expedites the connection and separation of prosthetic teeth to and from dental models and can be employed in conjunction with dry set dowel pins.

### DESCRIPTION OF RELATED ART

The present invention improves on a technology described in three patents issued to the same inventor, namely, U.S. Pat. Nos. 5,658,147, 5,788,494 and 5,934,906. Priority to the applications leading to these patents is not claimed. However, these patents are incorporated herein by reference.

It is known in the art to implant replicated teeth that have been removed or are otherwise missing. A replicated tooth designed for implantation is referred to herein as a “prosthetic tooth.” Often, a single prosthetic is made to replicate multiple adjacent missing teeth. Accordingly, it should be understood that the phrase “prosthetic tooth” as used herein also embraces the replication of multiple teeth.

A prosthetic tooth generally comprises a hollow core, surrounded by a metal abutment which, in turn, is surrounded by a ceramic facing. The ceramic facing is shaped to replicate, as nearly as possible, the missing tooth. The core of the prosthetic tooth is open at both ends. Surrounding one end of the core is an engaging head with a geometric recess.

It is known in the art to attach a prosthetic tooth to a patient's jaw using an “implant fixture” that is embedded in the patient's jaw by osseointegration. Implant fixtures generally comprise an internally and externally threaded hollow tube with an opening at one end. Surrounding the open end of the implant fixture is an engaging head with a raised geometric abutment. The shape of the abutment corresponds, inversely, to the shape of the recess on the engaging head of the prosthetic tooth. To accomplish attachment, the recess on the engaging head of the prosthetic tooth is placed around the abutment on the engaging head of the implant fixture. This provides a non-rotating friction fit. Then, a headed screw is passed through the core of the prosthetic tooth and rotated into the internal threads of the implant fixture until the screw head rests on a ridge inside the core of the prosthetic tooth. This provides a more permanent attachment. Afterwards, the exposed opening in the prosthetic tooth is capped with porcelain, or some other material, so that it is not readily apparent to the naked eye.

It is known in the art to facilitate the design of a prosthetic tooth with an accurate replica of the patient's teeth and gums called a “dental model.” The dental model usually includes some form of analog, generally called an “analog pin,” that replicates the initial engaging portions of the implant fixture. “Initial engaging portions” means the raised abutment on the head of the implant fixture and a portion of the internal threading in the implant fixture.

Dental models containing analog pins are typically created by a multi-step process. First, a coping is fitted onto an implant fixture that is, in turn, affixed to a patient's jaw by osseointegration. To coping and implant fixture fit together because, like a prosthetic tooth, the coping contains an engaging head with a recess that inversely corresponds to the abutment on the engaging head of the implant fixture. Second, an impression material is placed around a selected region of the mouth, including the coping, and allowed to set. Setting binds the coping to the impression. Third, the set impression, with bound coping, is removed from the patient's mouth and connected to an impression tray to provide a negative model of the selected portion of the patient's mouth. Fourth, an analog pin is friction fit to the engaging head on the coping. To accomplish this friction fit, the analog pin has an engaging head that mimics the engaging head of the implant fixture and, accordingly, fits into the recess on the head of the coping. In addition, the analog pin contains an internally threaded hollow that replicates at least a portion of the internal threading in the implant fixture. Fifth, die stone is poured into the dental impression and permitted to set. When the die stone sets, it forms a dental model that has an analog pin affixed therein. Sixth, the dental model is removed from the impression. As a result of the process, the engaging head on the analog pin is exposed on the tooth bearing surface of the dental model at the exact point where attachment of a prosthetic tooth is desired.

During the design process, the prosthetic tooth is repeatedly installed on, and subsequently removed from, the dental model. This is necessary to insure that the prosthetic tooth will function and appear naturally in the patient's mouth. Generally, installation and removal has been accomplished in a manner identical to final installation and removal on an implant fixture. In other words, the engaging heads on the prosthetic tooth and analog pin are contacted and then a headed screw is passed through the hollow core of the prosthetic tooth into the internal threads of the analog pin. Often, a specially designed screw driver is required. Accordingly, attachment, removal and reattachment of the implant has been a laborious and time consuming process.

The invention described in U.S. Pat. Nos. 5,658,147, 5,788,494 and 5,934,906 greatly simplified this process. As described therein, an assembly comprising an analog pin and a sleeve is utilized. The prosthetic tooth is screwed into the analog pin. The analog pin, in turn, slides through, and snaps into, the sleeve. The sleeve, in turn, is permanently fixed to the dental model. Accordingly, removal of the prosthetic tooth from the dental model no longer requires unscrewing a screw. Instead, the analog pin, and attached prosthetic tooth, quickly snap out of, and back into, the sleeve as a single unit. When the prosthetic tooth is removed from the dental model, the analog pin remains attached and provides a handle to better manipulate the prosthetic tooth during finishing.

Unfortunately, the assembly described in U.S. Pat. Nos. 5,658,147 and 5,788,494 and 5,934,906, like prior art analog pins, is not well adapted for use with dry set dowel pins. Dry set dowel pins are a device commonly utilized in the dental industry to facilitate the design of tooth restorations, as opposed to tooth replacements. Dowel pins are a means for supporting sectioned dies on a dental model. Each section, or die, consists of one or more replicated teeth connected to a base in the dental model by the dowel pins.

The conventional process for setting dowel pins is called “dry set” and involves a number of steps. First, die stone is poured in excess into a dental impression previously made from the patient's mouth. Once the die stone sets, it creates a “die model.” Second, the die model is removed and its underside is trimmed and leveled—using, for instance, a grinding stone. This produces a smooth flat surface on the bottom of the dental model close to the underside of the replicated teeth. Third, holes are drilled into the bottom of the dental model. The holes are positioned immediately below the portions of the die model that replicate teeth in need of restoration. Fourth, dowel pins are fastened into the holes. Dowel pins generally comprise a fastening portion that is relatively short, rough, and thin and a pin portion that is relatively long, smooth, and tapered. The dowel pins fit into a dowel sleeve. The fastening portion is inserted into the dowel pin holes and attached, for example, by an adhesive. Once fastened, the pin portion projects away from the underside of the die model. The pin portion of the dowel pin is then sheathed into the dowel sleeve. Fifth, the base is formed. This is done by pouring base stone into a base former (or reservoir) and inserting the die model, sleeved dowel pins first, into the base former. The base sets underneath the die model and around the dowel sleeves. Sixth, the die model is lifted off the base. Removal can be facilitated by using different types of die stone in the model and base and/or positioning a thin intermediate plastic layer between the die stone and base prior to pouring the base. Upon removal, the dowel pins slide out of the dowel sleeves—which remain fixed to the base. Seventh, and finally, the desired sections, or dies, are cut. Each die in the dental model consists of one or more replicated teeth. Each die in the dental model has dowel pins extending from the underside to permit proper positioning and easy placement and removal from the base.

Analog pins, including those described in the assemblies of U.S. Pat. Nos. 5,658,147 and 5,788,494 and 5,934,906, are not well adapted for use with dry set dowel pins. In contrast to dry set dowel pins, analog pins are positioned prior to casting and remain exposed on the tooth bearing surface of the dental model. Accordingly, when the die model is trimmed and leveled close to the underside of the replicated teeth, as required to dry set dowel pins, the previously positioned analog pins are severed or otherwise destroyed.

This is not to say that there is no means known in the art that permits the use of dowel pins in conjunction with analog pins. In fact, FIG. 3 in U.S. Pat. Nos. 5,658,147 and 5,788,494 and 5,934,906 show that the present inventor has successfully created such an arrangement. However, in such cases, the dowel pins are set using a process called “wet set.” This process is more complicated, more prone to error, and less familiar to dental practitioners than the aforementioned “dry set” process.

In the wet set process, dowel pins are inserted into the die stone before the die stone sets, e.g., while the stone is still wet. There is no trimming and/or leveling prior to positioning the dowel pins. Accordingly, extreme care must be taken not to place the dowel pins too deep or to shallow in the die stone, or in the wrong position, or at the wrong angle. Even experienced practitioners make mistakes using the wet set process.

Accordingly, it would be advantageous to develop an assembly that permits an analog pin to be used in conjunction with dry set dowel pins. This would enhance the ability to design prosthetic teeth and tooth restorations for a single patient on a single dental model. Additionally, it would be desirous to design such an assembly in a manner that utilizes the quick connect features of the assembly described in U.S. Pat. Nos. 5,658,147 and 5,788,494 and 5,934,906.

### BRIEF SUMMARY OF THE INVENTION

The invention is directed to an assembly that connects prosthetic teeth to dental models. The assembly forms a two part analog pin that snaps into a sleeve. Also disclosed are kits for installing the assembly, dental models that contain the assembly, and methods for making dental models that contain the assembly. The assembly expedites the connection and separation of prosthetic teeth to and from a dental model and can be employed in conjunction with dry set dowel pins.

The principle components of the assembly are as follows: (i) an engaging head; (ii) a tail; and (iii) a sleeve. Optionally, but preferably, a pin relief is also employed.

The engaging head can be divided into upper, middle and lower portions. The upper portion contains a raised abutment and an opening and mimics the engaging head on an implant fixture. The middle portion contains an internally threaded hollow tube that extends to the opening and mimics at least a portion of the internal threads on an implant fixture. The lower portion contains a vertical projection.

The tail comprises a pin attached to the lower portion of the analog engaging head. When attached, the tail projects away from the analog engaging head. Connection may be accomplished by a variety of means, including friction fit mechanisms, interlocking spiral threads, and/or an adhesive. The engaging head and tail are designed to connect together to form an two part analog pin.

The sleeve comprises a hollow tubular body, open at both ends, that has a shorter axial length than the two part analog pin. The sleeve fits around the lower portion of the engaging head and most of the tail of the two part analog pin.

Additionally, and preferably, the assembly contains a pin relief. The pin relief contains a hollow that fits around the lower portion of the tail. The pin relief serves to lock the two part analog pin in place.

Kits for installing the assembly into a dental model include the aforementioned engaging head, tail, sleeve and pin relief. The kits additionally contain a cavity preserver. The cavity preserver is a soft, hollow, tubular body, generally made of rubber, open at one or both ends. The cavity preserver is longer than the lower portion of the engaging head. The cavity preserver is designed to fit around the lower portion of the engaging head prior to casting a model.

Dental models that contain the assembly contain the two part analog pin formed by attaching the tail to the engaging head. The two part analog pin is snapped into a sleeve that is, in turn, fixed to a cast base. Preferably, the dental models also contain a pin relief. One of the advantages of the invention is that the dental models may also contain one or more sectioned dies connected to a base by one or more dry set dowel pins.

Dental models that contain the assembly can be produced by a method comprising at least the following steps:

(i) positioning the engaging head onto a coping in a dental impression;

(ii) casting and setting a dental impression to form a die model affixed to the engaging head;

(iii) attaching the tail to the lower portion of the engaging head;

(iv) placing the sleeve around the lower portion of the engaging head and upper and middle portions of the tail; and

(v) casting a base to form a dental model.

The invention is further described in the following illustrative drawings and detailed description.

### BRIEF DESCRIPTION OF THE DRAWINGS

FIG. 1 illustrates a conventional core aligned with a conventional implant fixture.

FIG. 2 illustrates a conventional prosthetic tooth.

FIG. 3 illustrates a conventional prosthetic tooth aligned with a conventional implant fixture analog.

FIG. 4 illustrates the attachment of a conventional prosthetic tooth to a conventional dental model.

FIG. 5 illustrates the attachment of a conventional prosthetic tooth to a conventional implant fixture embedded in a patient's mouth.

FIG. 6 illustrates a kit made in accordance with the invention.

FIGS. 7(A), 7(B), 7(C), 7(D), 7(E) and 7(F) illustrate the interaction between components of the invention.

FIGS. 8(A), 8(B), 8(C), 8(D) and 8(E) illustrate steps for using the invention in conjunction with a die model and dry set dowel pins.

### DETAILED DESCRIPTION OF THE INVENTION

The invention improves upon the technology described in FIGS. 1-5. The invention also improves upon the technology described in three patents issued to the same inventor, namely, U.S. Pat. Nos. 5,658,147, 5,788,494 and 5,934,906, the disclosures of which are incorporated herein by reference.

FIG. 1 illustrates a conventional implant fixture 110 and core 120. The implant fixture 110 is a hollow tubular device that contains: (1) an engaging head 111 that contains a raised abutment 112 thereon to facilitate engagement with a prosthetic tooth; (2) a threaded exterior 112 to facilitate osseointegration into a patient's jaw and prevent retrograde movement after installation; and (3) a threaded socket (not shown) that extends axially into the implant fixture 110 to facilitate reception of a screw shaft. The core 120 is a hollow tubular device that contains an engaging head 121 that contains a recess (not shown) that is proportionate to the abutment 112 on the engaging head 111 of the implant fixture 110. The core 120 has a hollow interior 121, open at each end 121a and 121b, adapted to receive a headed screw (not shown). The upper portion 122a of the interior surface 121 of the core 120 has a relatively large diameter adapted to receive the head of a screw. The lower portion 122b of the interior surface 121 of the core 120 has a relatively narrow diameter adapted to receive the shank of a headed screw. The upper 122a and lower 122b portions of the interior surface 121 of the core 120 cooperate to form a shoulder 123 for seating the head of a screw.

FIG. 2 illustrates a conventional prosthesis 210 of the UCLA-type that contains two replicated teeth 220 and 221. The prosthesis 210 comprises a core 120 (such as the core shown in FIG. 1) and an integrally formed abutment 230. The abutment 230 is typically formed of metal, usually gold. A ceramic facing 240, typically porcelain, is formed over the abutment 230 to replicate the dentition.

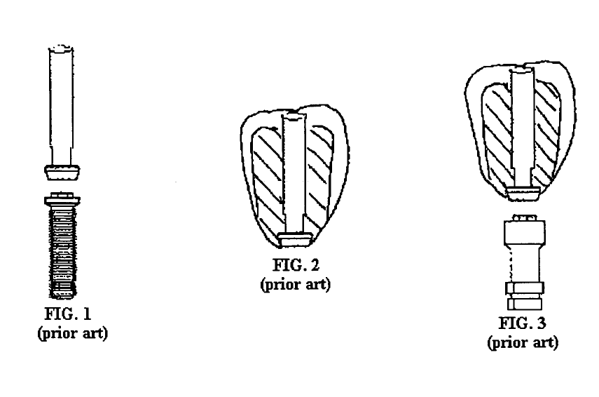

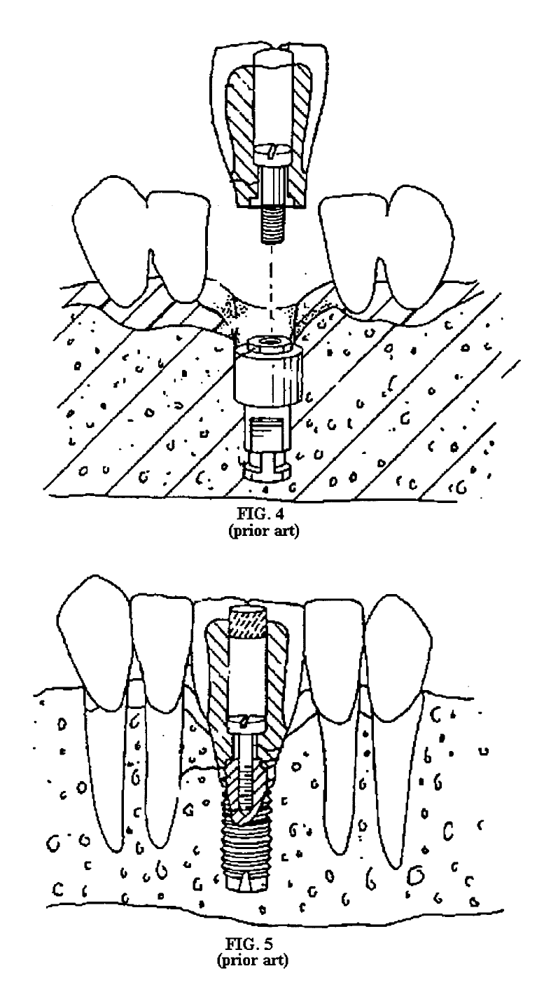

FIG. 3 illustrates the alignment of a prosthesis 210 (such as the prosthesis shown in FIG. 2) with a conventional analog pin 310. The analog pin 310 contains an engaging head 311 with a raised abutment 312 that corresponds to the abutment 112 on the engaging head 111 on the implant fixture 110. The engaging head 311 facilitates engagement of the analog pin 310 with the prosthesis 210. The analog pin contains ridges 220 to facilitate bonding to dental model casting materials (not shown). A threaded socket (not shown) extends axially into the analog pin 310 to enable reception a screw (not shown).

FIG. 4 illustrates a known procedure for mounting a prosthesis 210 (such as that shown in FIG. 2) to a dental model 410 using an analog pin 310 (such as that shown in FIG. 3). The analog pin 310 is physically affixed to the dental model 410 by positioning the analog pin in casting material used to make the dental model 410 prior to setting. The raised abutment 312 on the engaging head 311 of the analog pin 310 is structured to cooperate with the recess on the engaging head 121 of the core 110 of the prosthesis 210, so that the prosthesis 210 sits on the analog pin 310 in a manner that prevents rotational movement. A headed screw 420 is passed through the core 110 in the prosthesis 210 and rotated into the threaded screw shaft of the analog pin 310 to affix the prosthesis 210 to the analog pin 310.

FIG. 5 illustrates a known procedure for attaching a prosthesis 210 (such as that shown in FIG. 2) to a patient's jaw 510 using an implant fixture 110 (such as that shown in FIG. 1.) The prosthesis 210 is mounted onto the implant fixture 110 after it has been fixed into the patient's jaw 510 by the medium of osseointegration. The raised abutment 112 on the engaging head 111 of the implant fixture 100 is structured to interact with the recess on the engaging head 121 of the core 110 of the prosthesis 210 to insure that the prosthesis 210 does not rotate on the implant fixture 110. A headed screw 520 is passed through the core 110 in the prosthesis 210 and rotated into the threaded screw shaft of the implant fixture 110 to affix the prosthesis 210 to the implant fixture 110. The exposed end 121a of the hollow core 120 of the prosthesis 210 is capped with a plug 530 of porcelain or some other material.

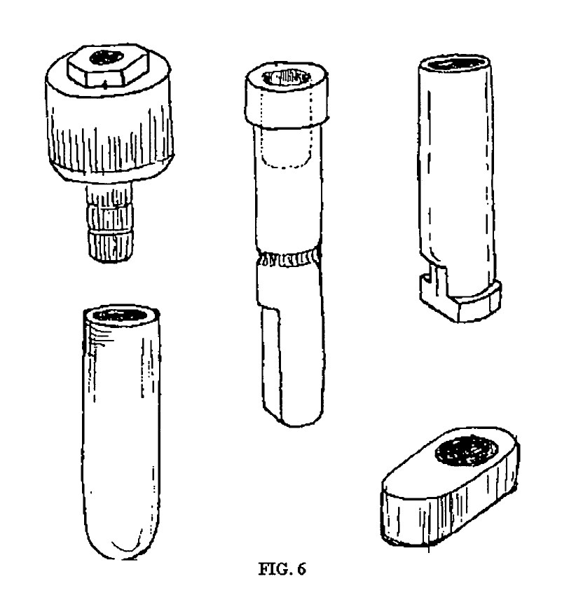

FIG. 6 illustrates a kit 600 made in accordance with the present invention. The kit 600 contains an engaging head 610, a cavity preserver 620, a tail 630, a sleeve 640 and a pin relieve 650.

The engaging head 610 can be divided into upper 611a, middle 611b and lower 611c portions. The upper portion 611a contains a geometric abutment 612 that surrounds a central opening 613 and mimics the abutment 112 on the engaging head 111 of an implant fixture 110. For example, the abutment 612 may be a raised hollow hexagon. The middle portion 611b contains an internally threaded hollow tube 614. Preferably, the outer surface of the tube 614 contains ridges 615. More preferably, the ridges 615a run vertically down the outer surface of the tube 614. The ridges 615a provide an uneven surface which facilitates the adhesion of the engaging head 610 to casting material as it constricts during the setting process. The lower portion 611c contains a vertical projection 616. Preferably, the outer surface of the vertical projection 616 contains ridges 615b and/or threads (not shown) that assist attaching the engaging head 110 to the tail 130 by adhesive and/or interlocking threads, respectively.

The engaging head 610 is relatively short, i.e., no more than 0.5 inches (i.e., 0.25 inches) in length. Thus, the engaging head 610 is smaller than the width of typical die models, even after the die models are trimmed and leveled. Accordingly, the engaging head 610 is not damaged if it is affixed to a die model that is trimmed and leveled to permit the dry setting of dowel pins.

The cavity preserver 620 is a soft, hollow, tubular body, with an opening 621 on at least one end. For instance, the cavity preserver 620 may be a piece of rubber tubing. The cavity preserver 620 is generally softer and longer than the lower portion 611c of the engaging head 610. The function of the cavity preserver 620 is to extend away from the lower portion 611c of the engaging head 610 and, thereby, preserve a cavity leading to the engaging head 610 during the casting, curing, grinding and trimming of a die model. The cavity preserver 620 should be soft enough that its length is easily ground and trimmed, similar to cast material. Thus, when the underside of the die model is trimmed and leveled to permit the dry setting of dowel pins, the cavity preserver 620 is also trimmed and leveled. When trimming and leveling is complete, the remnants of the cavity preserver 620 are removed and discarded. When the cavity preserver 620 is removed, a hole remains in the die model that permits access to the engaging head 610.

The tail 630 is a pin structure designed to connect to the engaging head 630 to form a two part analog pin (not shown) after the initial casting, grinding and trimming of a die model. The tail 630 attaches to the lower portion 611c of the engaging head 630 through a cavity in the die model that is created by the cavity preserver 620 and exposed when the cavity preserver 620 is removed. The two part analog pin, when assembled, is similar to those described in U.S. Pat. Nos. 5,658,147 and 5,788,494 and 5,934,906.

The tail 630 is divided into upper 631a, middle 631b and lower 631c portions. When attached to the engaging head 610, the tail 630 projects away from the engaging head 610. Attachment can be accomplished by a number of means including friction fit, interlocking thread, and/or an adhesive. Preferably, the tail 630 contains an opening 632 in the upper portion 631a that facilitates attachment. The opening 632 fits around the lower portion 611c of the engaging head 610 to form a friction fit. Preferably, the fit is made more permanent by deploying an adhesive into the opening 632 before the fit is made. The ability of the adhesive to bind to the internal surface of the opening 632 may be facilitated by the incorporation of threads or ridges on the internal surface.

The tail 630 contains a slight surface undulation 633 somewhere on its surface. The undulation 633 is designed to interact with sleeve 640 to prevent axial movement of the two part analog pin when it is sheathed in the sleeve 640.

The tail 630 contains a flat 634 or equivalent structure somewhere on one side of its surface. The flat 634 cooperates with the sleeve 640 to insure that there is no rotational movement of the two part analog pin when it is sheathed in the sleeve 640.

Preferably, the tail 630 contains an indentation 635 on the lower portion 631c. The indentation 635 is designed to engage a pin relief 650 and, thereby, provide an additional locking mechanism to prevent unintended axial movement of the two part analog pin when it is sheathed in the sleeve 640.

The sleeve 640 is hollow tubular body that has an upper opening 641a and a lower opening 641b (not shown). The sleeve 640 fits around portions of the two part analog pin, e.g., around the lower portion 111c of the engaging head 610 and the upper 131a and middle 131b portions of the tail 630. Preferably, the two part analog pin is sufficiently longer in axial length than the sleeve 630 to permit lower portion 631c of the tail 630 to extend through the bottom opening in the sleeve 640. This permits axial force to be exerted on the two part analog pin from below to remove the two part analog pin from the sleeve 640.

Surrounding the lower opening 641b is an annular flange 642. The annular flange 642 provides an uneven surface sufficient to affix sleeve 640 into a setting casting material.

The inside surface of sleeve 640 has a slight surface undulation 642 that interacts with the surface undulation 633 on the surface of tail 630. This provides the snap connection between the two part analog pin and sleeve 640. Axial force must be applied sufficient to move, or snap, the undulations past one another when installing and removing the two part analog pin.

The sleeve 640 contains a flat 643 or equivalent structure somewhere on at least its inside surface 644 (not shown), and preferably on its inside 644 and outside 645 surfaces. The flat 643 in the sleeve 640 corresponds to the dimensions of the flat 634 on the tail 630 and interacts with the flat 634 on the tail 630 to insure that the two part analog pin can only be inserted into the sleeve 640 in one direction, namely, the direction dictated when the flats align.

The pin relief 650 serves to further lock the two part analog pin into the sleeve 640. The pin relief 650 has a larger diameter than both the lower portion 631c of the tail 630 and the sleeve 640. The pin relief 650 attaches to the lower portion 631c of the tail 630 in a removable manner to prevent undesired axial movement of the two part analog pin within the sleeve 640. Removable attachment may be accomplished by a number of means including a snap fit and interlocking threads. Preferably, however, attachment is accomplished by hooking the indentation 635 on the lower portion 631c of the tail 630 into an opening 651 on the surface of the pin relief 650.

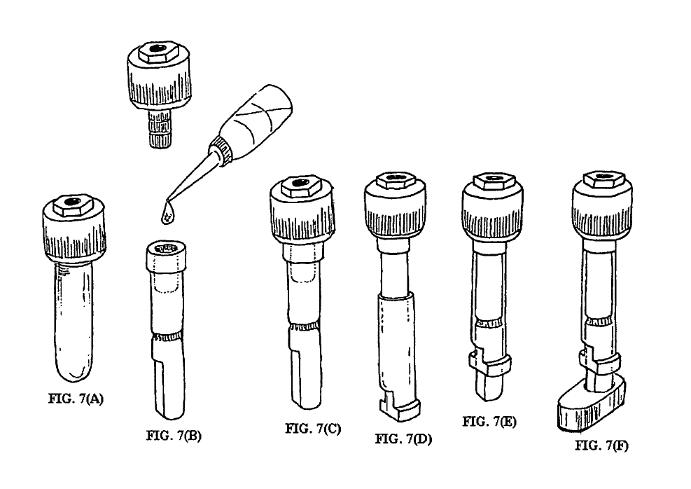

FIGS. 7(A), 7(B), 7(C), 7(D), 7(E), and 7(F) illustrate the interaction of various components in invention. Each interaction is shown in order it generally occurs when the invention is employed.

FIG. 7(A) shows an engaging head 610 connected to a cavity preserver 620. The opening 621 (not visible) in the cavity preserver 620 is sufficiently wide and sufficiently deep to contain the lower portion 611c (not visible) of the engaging head 610, but insufficiently wide and/or insufficiently deep to contain the upper 611a and middle 611b portions of the engaging head 610. The cavity preserver 620 is longer than the lower portion 611c of the engaging head 610.

FIG. 7(B) shows an adhesive 710 being poured into an opening 632 in upper portion 631a of the tail 630 to facilitate attachment of engaging head 610 to tail 630. FIG. 7(B) also shows an engaging head 610 aligned to attach to the opening 632 in the upper portion 631a of the tail 630. At this point, the cavity preserver 620 has been removed from the engaging head 610.

FIG. 7(C) shows an engaging head 610 adhered to a tail 630. This two part structure forms analog pin 720.

FIG. 7(D) shows the two part analog pin 720 partially inserted into sleeve 640. FIG. 7(E) shows the two part analog pin 720 fully inserted into sleeve 640. A portion 730 of the two part analog pin 720 protrudes from the lower opening in the sleeve 640.

FIG. (7F) shows the two part analog pin 720 fully inserted into sleeve 640. The portion 730 that protrudes from the lower opening in the sleeve 640 rests in pin relief 650.

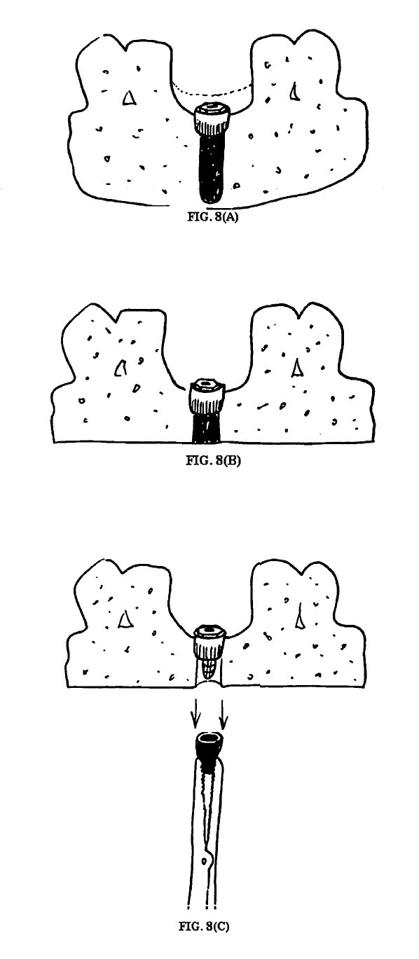

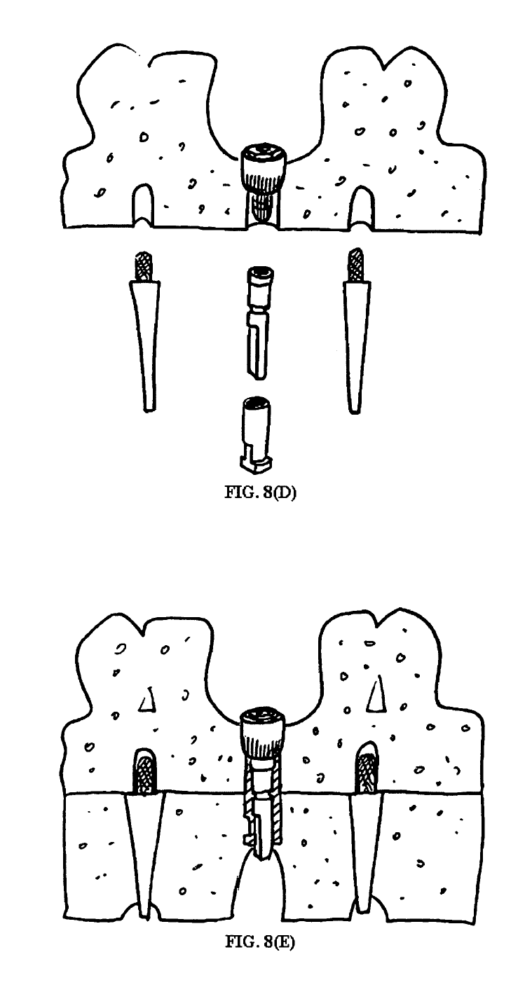

FIGS. 8(A), 8(B), 8(C), 8(D) and 8(E) illustrate the various steps for using the invention in conjunction with a die model and dry set dowel pins. Each step is shown in the order it would generally occur when the invention is employed.

In FIG. 8(A), the engaging head 610 is connected to cavity preserver 620 and die stone is then cast and set to generate a die model 810. The upper surface 811a of the die model 810 contains one or more replicated teeth, 820a and 820b, and engaging head 610. Cavity preserver 620, at this point, is buried in the die model 810.

In FIG. 8(B), the lower surface 811b of die model 810 is trimmed and leveled in preparation for the dry setting of dowel pins. This step damages a portion of cavity preserver 620. Engaging head 610 is not damaged in this process.

In FIG. 8(C), cavity preserver 620 is removed using tweezers 830. Removal of cavity preserver 620 leaves a cavity 840 in the lower surface 811b of die model 810 that exposes the lower portion 611c of engaging head 610.

In FIG. 8(D), two holes 850a and 850b are drilled into the lower surface 811b of die model 810. A dowel pin, 860a and 860b, is then aligned with each hole. Dowel pins 860a and 860b are to be affixed into holes 850a and 850b, respectively, by any number of means, including an adhesive. To create binding sites for an adhesive, each dowel pin usually contains a patterned upper portion 861a and 861b.

In addition, the upper portion 631a of tail 630 is aligned with the lower portion 611c of engaging head 610 in die model 810, which is now exposed by cavity 840. In turn, sleeve 640 is aligned with tail 630 so that the flat 643 on the sleeve 640 is aligned with the flat 634 on the tail 630. The upper portion 631a of tail 630 is to be affixed to the lower portion 611c of engaging head 610 by, for example, an adhesive, to create the two part analog pin. The two part analog pin will then be sheathed in sleeve 640.

In FIG. 8(E), a complete dental model 888 is shown. Dowel pins, 816a and 816b, have been attached to die model 810 and sheathed in dowel sleeves 817a and 817b. In addition, engaging head 610 and tail 630 have been connected to form a two part analog pin 720. The two part analog pin 720, in turn, has been sheathed in the analog pin sleeve 640. Subsequently, a base 870 has been cast around the exposed portions of analog pin sleeve 640 and dowel sleeves 860a and 860b. The base sets and, in so doing, contracts, to permanently bind the sleeves 640, 860a and 860b into the base 870. The annular flange 642 on the analog pin sleeve 640 and surface irregularities on the dowel pin sleeves assist in binding the devices to the base 870b.

There is a horizontal dividing line 870a between die model 810 and base 870 defined by different casting materials and/or a thin plastic divider positioned prior to casting the base 870. Similarly, there are vertical dividing lines 871a and 871b that represent cuts made in the die model to permit dies 880a and 880b to be separated from the remainder of die model 810. When this happens, the dowel pins 816a or 816b associated with each die 880a or 880b separates from its respective dowel sleeve 817a or 817b.

A portion of the tail 630 on the analog pin 720 extends outside the analog pin sleeve 640. The analog pin 720 can be removed simply by applying upward axial force to the tail 630. Accordingly, a prosthetic tooth 210 attached to the analog pin 720 can be easily snapped out of, and snapped into, the sleeve 640 and, thereby, the dental model 888.

As is apparent from FIG. 8(E), the invention permits an analog pin 720 to be set and utilized in conjunction with the setting and utilization of dry set dowel pins 816a or 816b. In addition, the invention preservers the quick snap connection capabilities of the assembly described in U.S. Pat. Nos. 5,658,147, 5,788,494 and 5,934,906.

A method for making a dental model comprising the invention entails the following steps. First, one positions the engaging head onto a coping in a dental impression. Second, one casts and sets a dental impression to form a die model affixed to the engaging head. Third, one attaches the tail to the lower portion of the engaging head, wherein said tail is comprises a pin divided into upper, middle and lower portions, and wherein said pin projects away from the engaging head. Fourth, on places a sleeve around the lower portion of the engaging head and upper and middle portions of the tail. Fifth, one casts a base to form the remainder of the dental model

Preferably, a method for making a dental model comprising the invention entails the following steps. First, one positions the engaging head onto a coping in a dental impression. Second, one places the cavity preserver onto the lower end of the engaging head. Third, one casts and sets a die model that affixes the engaging head. Fourth, one trims and/or levels the underside of the die model and attaches dowel pins. Fifth, one removes the cavity preserver or any remnants of the same. Sixth, one attaches the tail to the lower portion of the engaging head. Seventh, one places the sleeve around the lower portion of the engaging head and upper and middle portions of the tail. Eighth, one attaches a pin relief to the lower portion of the tail. Ninth, one casts the base to form the remainder of the dental model. Tenth, and finally, the die model is cut to form sectioned dies.

It should be understood that a number embodiments of the invention are possible. In addition, a number of equivalents may exist which remain consistent with the heart of the invention. Accordingly, the scope of the invention for which protection is sought is defined by the following claims and any equivalents thereof.

1. An assembly comprising the following components:
(i) an engaging head divided into upper, middle and lower portions, wherein the upper portion contains a raised abutment and an opening, the middle portion contains an internally threaded hollow tube with outer and inner surfaces, and the lower portion contains a vertical projection, and
(ii) a tail comprising a pin attached to the lower portion of the engaging head, wherein said tail has an outer surface and projects away from the engaging head; and
(iii) a sleeve comprising a hollow tubular body, open at both ends, that has outer and inner surfaces and fits around the lower portion of the of the engaging head and most of the tail.

2. The assembly of claim 1, wherein the upper portion of the engaging head contains a raised abutment that encircles an opening.

3. The assembly of claim 1, wherein the middle portion of the engaging head contains an outer surface that is uneven.

4. The assembly of claim 1, wherein the tail contains one or more undulations on its outer surface that facilitate a snap connection with the sleeve.

5. The assembly of claim 1, wherein the tail has one end that contains an opening and another end whose outer surface is at least partially flattened.

6. The assembly of claim 1, wherein the tail has one end that contains an opening and attachment of the tail to the engaging head is facilitated by inserting this opening over the lower portion of the engaging head.

7. The assembly of claim 1, wherein attachment of the tail and engaging head is facilitated by an adhesive.

8. The assembly of claim 1, wherein the sleeve contains one or more undulations on its inner surface that facilitate a snap connection with the tail.

9. The assembly of claim 1, wherein the sleeve has one end whose inner surface is at least partially flattened.

10. The assembly of claim 1, additionally comprising a pin relief that fits over one end of the tail after the tail is inserted into the sleeve.

11. A kit for use in making an assembly that partially replicates an implant fixture in a dental model comprising the following components:
(i) an engaging head divided into upper, middle and lower portions, wherein the upper portion contains a raised abutment and an opening, the middle portion contains an internally threaded hollow tube with outer and inner surfaces, and the lower portion contains a vertical projection, and
(ii) a cavity preserver that is softer and longer than the lower portion of the engaging head, formed from a hollow tubular body open on at least one end, capable of fitting around the lower portion of the engaging head;
(iii) a tail comprising a pin; and
(iv) a sleeve comprising a hollow tubular body, open at both ends, that has outer and inner surfaces and fits around the lower portion of the of the engaging head and most of the tail.

11. The kit of claim 10, wherein the upper portion of the engaging head contains a raised abutment that encircles an opening.

12. The kit of claim 10, wherein the middle portion of the engaging head contains an outer surface that is uneven.

13. The kit of claim 10, wherein the cavity preserver is a rubber tube.

14. The kit of claim 10, wherein the tail contains one or more undulations on its outer surface that facilitate a snap connection with the sleeve.

15. The kit of claim 10, wherein the tail has one end that contains an opening and another end whose outer surface is at least partially flattened.

16. The kit of claim 10, wherein the sleeve contains one or more undulations on its inner surface that facilitate a snap connection with the tail.

17. The kit of claim 1, wherein the sleeve has one end whose inner surface is at least partially flattened.

18. The kit of claim 1, additionally comprising a pin relief that has an opening tht fits over one end of the tail.

19. A dental model comprising:
a sleeve affixed to a base;
a two part analog pin that replicates at least some of the engaging mechanisms in an implant fixture;
one or more dry set dowel pins.

20. A method for making a dental model comprising the following steps:
(i) positioning an engaging head onto a coping in a dental impression, wherein said engaging head is divided into upper, middle and lower portions, wherein the upper portion contains an abutment that mimics an engaging head on an implant fixture, wherein the middle portion contains an internally threaded hollow tube open at one end that mimics at least a portion of the internal threads on an implant fixture, and wherein the lower portion contains a vertical projection;
(ii) casting and setting a dental impression to form a die model affixed to the engaging head;
(iii) attaching a tail to the lower portion of the engaging head, wherein said tail is comprises a pin divided into upper, middle and lower portions, and wherein said pin projects away from the engaging head;
(iv) placing a sleeve around the lower portion of the engaging head and upper and middle portions of the tail; and
(v) casting a base to form a dental model.
